(19) United States
(12) Patent Application Publication
(10) Pub. No.: US 2026/0160344 A1
(43) Pub. Date: Jun. 11, 2026

(54) COOLANT DISTRIBUTOR FLAPPER VALVE

(71) Applicant: Stoneridge Control Devices, Inc., Novi, MI (US)

(72) Inventor: Robert James Steinman, Lexington, OH (US)

(21) Appl. No.: 18/970,237

(22) Filed: Dec. 5, 2024

(51) Int. Cl. F16K 11/052; F28F 27/02; H01M 10/613; H01M 10/625; H01M 10/6568

(52) U.S. Cl. CPC F16K 11/0525; F28F 27/02; H01M 10/613; H01M 10/625; H01M 10/6568; H01M 2220/20

(57) ABSTRACT

A fluid valve includes a housing that has a port wall with first and second ports, a drive assembly that has an output drive, and a compound gate valve that is arranged in the housing and includes a shaft that supports first and second gates. The shaft is operatively coupled to the output drive. The shaft has a shaft axis. The shaft is configured to rotate about the shaft axis in response to the output drive between a first position in which the first gate seals against the first port and a second position in which the second gate seals against the second port, and a location of the shaft axis is configured to remain fixed relative to the port wall during rotation of the shaft between the first and second positions.

### TECHNICAL FIELD

This disclosure relates to a fluid distributor valve for use in vehicle cooling systems, for example.

### BACKGROUND

A typical modern vehicle includes various components and subsystems for which it is desirable to regulate the temperature (i.e., heating and/or cooling to a desired temperature). One or more cooling loops include one or more heat exchangers through which one or more fluids are circulated in a controlled manner to provide cooling fluid at a desired temperature to the components. As vehicles have become more complex, the complexity of the cooling system has increased as well.

A typical cooling system found in vehicles such as those having electrified and/or hybrid drivetrains tend to be highly distributed architectures with a complex maze of cooling loops, sub-loops, pumps, and heat exchanges. Coolant distributor valves, controllers and temperature sensors used to direct the coolant through these cooling systems are separated from one another and distributed throughout the vehicle. The resultant cooling system is complicated and expensive to implement and maintain, and the coolant temperature may not be as accurately regulated as desired.

The coolant distributor valves themselves can be relatively complex as well, which is undesirable. One such example is a compound gate valve that rotates eccentrically while translating in a slot. The motion of the compound gate valve complex, which can introduce failure modes and add cost. Moreover, this type of compound gate valve extends to opposing walls for sliding support, resulting in larger and heavier gates.

### SUMMARY

In one exemplary embodiment, a fluid valve includes a housing that has a port wall with first and second ports, a drive assembly that has an output drive, and a compound gate valve that is arranged in the housing and includes a shaft that supports first and second gates. The shaft is operatively coupled to the output drive. The shaft has a shaft axis. The shaft is configured to rotate about the shaft axis in response to the output drive between a first position in which the first gate seals against the first port and a second position in which the second gate seals against the second port, and a location of the shaft axis is configured to remain fixed relative to the port wall during rotation of the shaft between the first and second positions.

In a further embodiment of any of the above, the output drive has a drive axis. The drive axis and the shaft axis are coaxial with one another.

In a further embodiment of any of the above, the output drive has a drive axis. The drive axis and the shaft axis are offset from one another. The compound gate valve includes a sector gear that is supported by the shaft. The output drive is in meshing engagement with the sector gear.

In a further embodiment of any of the above, the drive assembly includes an electric motor that is arranged in the housing. The electric motor is configured to rotate the output drive.

In a further embodiment of any of the above, the shaft axis extends in a first direction, and the first and second gates respectively lie in first and second planes. The first and second planes extend in the first direction.

In a further embodiment of any of the above, the first and second planes intersect at the shaft axis.

In a further embodiment of any of the above, the port wall includes an arcuate recess, and the shaft is slidably supported in the arcuate recess during rotation about the shaft axis between the first and second positions.

In a further embodiment of any of the above, the shaft includes an arcuate flange, and the port wall includes a groove that receives the flange and locates the compound gate valve along the shaft axis.

In a further embodiment of any of the above, the compound gate valve includes a reinforcing gusset bridging the first and second gates.

In a further embodiment of any of the above, the compound gate valve includes first and second seals that are respectively supported on the first and second gates and configured to respectively engage the first and second ports to block its respective port.

In a further embodiment of any of the above, the first and second ports are arranged at an angle of less than 180° relative to one another.

In a further embodiment of any of the above, the housing includes first and second walls spaced apart from one another and adjoining port wall on opposite sides from one another. The first and second gates are spaced from the first and second walls.

In a further embodiment of any of the above, the housing includes a cover that is secured to the first and second walls to enclose the compound gate valve within a fluid cavity in selective fluid communication with the first and second ports and a third port.

In a further embodiment of any of the above, a thermal management system includes at least one component that includes a battery, a heat exchanger, and the fluid valve that is fluidly arranged between the battery and the heat exchanger.

In another exemplary embodiment, a method of operating a fluid valve includes providing a port wall that provides first and second ports, supporting first and second gates on a shaft having a shaft axis, the shaft is operatively coupled to an output drive, moving the output drive, and rotating the first and second gates about the shaft axis between a first position in which the first gate seals against a first port and a second position in which the second gate seals against the second port. A location of the shaft axis is configured to remain fixed relative to the port wall during rotation of the shaft between the first and second positions.

These and other features of the present invention can be best understood from the following specification and drawings, the following of which is a brief description.

### BRIEF DESCRIPTION OF THE DRAWINGS

The disclosure can be further understood by reference to the following detailed description when considered in connection with the accompanying drawings wherein:

FIG. 1 is a schematic of one example vehicle cooling system.

FIGS. 2A and 2B are respectively a side view of an example fluid distributor valve and a perspective view of the same fluid distributor valve with a housing portion removed.

FIGS. 3A and 3B respectively are cross-sectional views taken along line 3A-3A in FIG. 2B and along line 3B-3B in FIG. 2A.

FIGS. 4A and 4B are views similar to FIG. 3B illustrating a compound gate valve in first and second positions.

FIG. 5 illustrates another compound gate valve and drive assembly configuration.

FIG. 6 is a perspective view of the compound gate valve and drive assembly configuration shown in FIG. 5.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

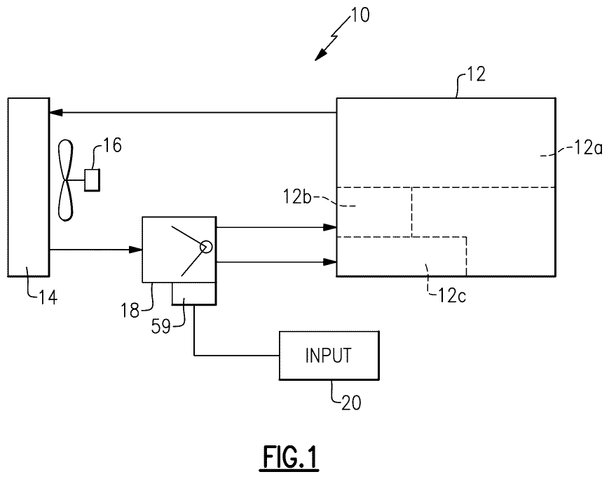

FIG. 1 illustrates, in a highly schematic fashion, a vehicle cooling system 10 that includes a heat generation system 12. The heat generation system 12 may comprise multiple heat sources 12a-12c, one of which may be a battery. A cooling fluid is circulated from at least one of the heat sources 12a-12c to a heat exchanger 14 by one or more pumps (not shown). A fan 16 may be used to increase a heat rejection rate from the heat exchanger 14. It should be understood that other forms of heat rejection may be used, such as a liquid-to-air heat exchanger or a liquid-to-liquid heat exchanger for example.

One or more coolant distributor valves 18 are used to direct the fluid flow through the cooling system 10 to achieve a desired temperature of the various components within the cooling system. In the example, this fluid valve 18 is fluidly arranged between the battery and the heat exchanger 14. An electric motor 59 may be used to actuate the fluid valve 18 between multiple positions in response to an input 20 used to regulate the temperature within the system.

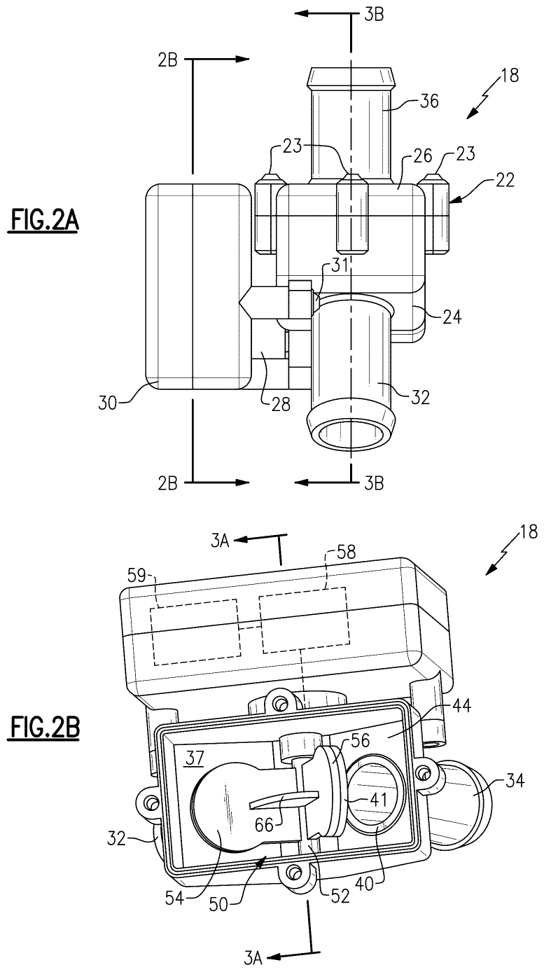

One example fluid valve 18 is shown in FIGS. 2A-4B. The fluid valve 18 includes a housing 22, which may comprise multiple housing portions, such as first, second, third and fourth housing portions 24, 26, 28, 30. The various housing portions may be secured using fasteners 23 and 31, sealant, glue, ultrasonic welding and/or with other securing techniques. More or fewer housing portions may be used than shown. In the example, the motor 59 and a drive assembly 58 are arranged in the third and fourth housing portions 28, 30 in a dry cavity separated from the coolant.

In the example, the fluid valve 18 is a three-port valve having first, second and third fluid connections 32, 34, 36, which are connected to components within the cooling system 10 via coolant lines. A skilled worker would understand the disclosed fluid valve 18 may include more fluid connections for a different arrangement of fluid connections than shown. At least a portion of the housing 22, for example, first and second housing portions 24, 26 provide a fluid cavity 37 in fluid communication with first, second, and third ports 38, 40, 42 that are respectively in fluid communication with the first, second and third fluid connections 32, 34, 36. The fluid cavity 37 is provided by the housing 22 at least in part by a port wall 44 and first and second walls 46, 48 that are spaced apart from one another and adjoin the port wall 44 on opposite sides from one another. The first and second ports 38, 40 are provided in the port wall 44, and arranged at an angle of less than 180° relative to one another but greater than 50° from one another (that is, canted inward toward the cavity 37 in the example shown).

With the example housing 22, the second housing portion 26 acts as a cover over the fluid cavity 37, enclosing its compound gate valve 50. The first and second gates 54, 56 are spaced from the first and second walls 46, 48, due to the simplified motion and design of the compound gate valve 50.

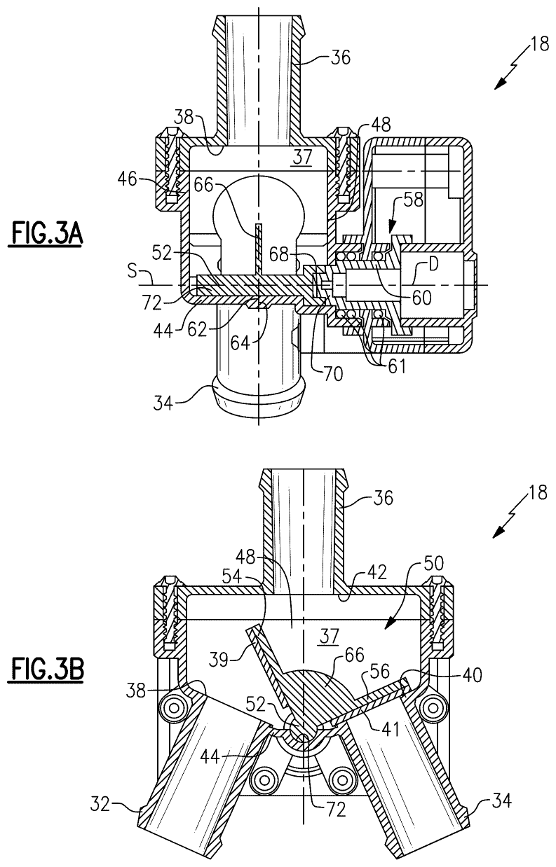

Referring to FIGS. 2B-3B, the compound gate valve 50 has a shaft 52 supporting first and second gates 54, 56 within the fluid cavity 37. In the example, the first and second gates 54, 56 support first and second seals 39, 41, respectively, to block its respective first and second port 38, 40. Alternatively, the seals 39, 41 may instead be provided on the port wall 44 circumscribing the first and second ports 38, 40.

The drive assembly 58 has an output drive 60 is operatively coupled to the shaft 52. The shaft 52 has a shaft axis S and the output drive 60 has a drive axis D that is coaxial with the shaft axis S in the example shown in FIG. 3A.

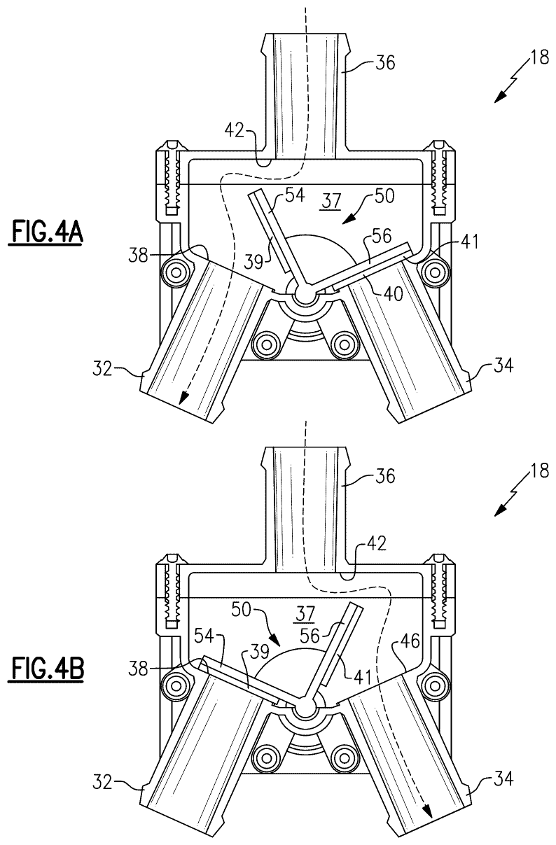

In the example, the port wall 44 includes an arcuate recess 72 in which the shaft 52 is slidably supported during rotation about the shaft axis S between the first and second positions shown in FIGS. 4A and 4B. The location of the shaft axis S is configured to remain fixed relative to the port wall 44 during rotation of the shaft 52 between the first and second positions (see, FIGS. 4A and 4B). That is, the shaft 52 does not move eccentrically or translate, which greatly simplifies the operation of the fluid valve 18 thus increasing is reliability and reducing cost. Additionally or alternatively, the shaft 52 may include an arcuate flange 62 extending radially relative to the shaft axis S that is received in a correspondingly shaped groove 64 in the port wall 44. Cooperation of the arcuate flange 62 with the groove 64 axially locates the compound gate valve 50 relative to the housing 52.

The drive assembly 58 may include the electric motor 59 either coupled directly to the shaft 52 or by an intervening gear assembly. In the example, the output drive 60 provides a lug 70 that mates with a socket 68 in an end of the shaft. Seals 61 are provided between the output drive 60 and its supporting housing 22.

A reinforcing gusset 66 may be provided between and bridging the first and second gates 54, 56. In the example shown, the reinforcing gusset 66 is axially aligned with the arcuate flange 62. Either or both of the arcuate flange 62 and the reinforcing gusset 66 may be omitted.

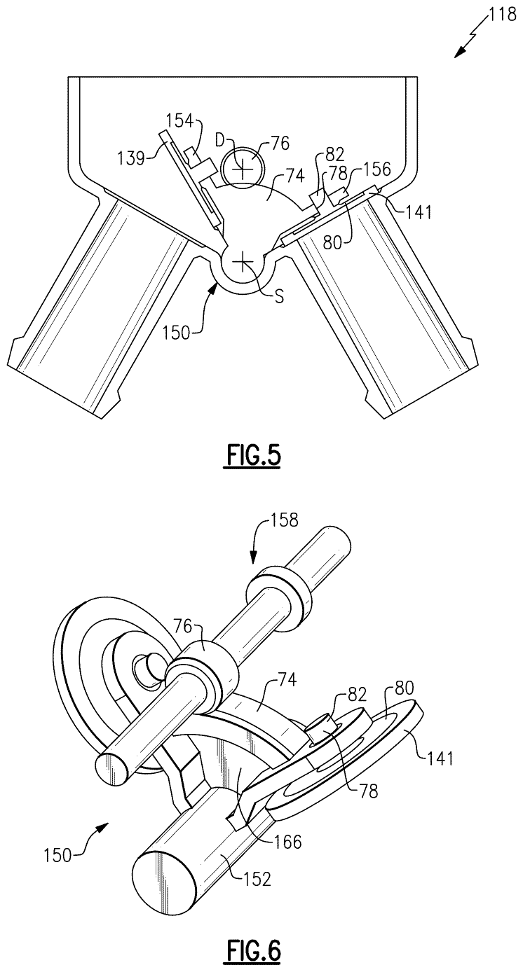

Another example compound gate valve 150 is shown in FIGS. 5 and 6. In this example, a sector gear 74 bridges the first and second gates 154, 156. The output drive 76 of drive assembly 158 meshes with the sector gear 74. The sector gear 74 also acts as a reinforcing gusset. The first and second seals 139, 141 are supported by a support 80 having a stem 82 received in a corresponding hole 78 in the first and second gates 154, 156. The stems 82 are retained in the holes 78 such that are supported by the gates, but permitted to rotate relative thereto to provide improved sealing relative to the seal's respective port.

In the example shown in FIGS. 2B-4B, the first and second gates 54, 56 respectively lie in first and second planes that intersect the shaft axis S (planes lie in same direction as shaft axis S), but this configuration need not be the case as shown in the example of FIGS. 5 and 6.

Although an example embodiment has been disclosed, a worker of ordinary skill in this art would recognize that certain modifications would come within the scope of the claims. For that reason, the following claims should be studied to determine their true scope and content.

What is claimed is:

1. A fluid valve comprising:
a housing having port wall with first and second ports;
a drive assembly having an output drive; and
a compound gate valve arranged in the housing and including a shaft supporting first and second gates, the shaft operatively coupled to the output drive, the shaft having a shaft axis, the shaft is configured to rotated about the shaft axis in response to the output drive between a first position in which the first gate seals against the first port and a second position in which the second gate seals against the second port, and wherein a location of the shaft axis is configured to remain fixed relative to the port wall during rotation of the shaft between the first and second positions.

2. The fluid valve of claim 1, wherein the output drive has a drive axis, the drive axis and the shaft axis are coaxial with one another.

3. The fluid valve of claim 1, wherein the output drive has a drive axis, the drive axis and the shaft axis are offset from one another, wherein the compound gate valve includes a sector gear supported by the shaft, the output drive in meshing engagement with the sector gear.

4. The fluid valve of claim 1, wherein the drive assembly includes an electric motor arranged in the housing, the electric motor configured to rotate the output drive.

5. The fluid valve of claim 1, wherein the shaft axis extends in a first direction, and the first and second gates respectively lie in first and second planes, the first and second planes extend in the first direction.

6. The fluid valve of claim 5, wherein the first and second planes intersect at the shaft axis.

7. The fluid valve of claim 1, wherein the port wall includes an arcuate recess, and the shaft is slidably supported in the arcuate recess during rotation about the shaft axis between the first and second positions.

8. The fluid valve of claim 7, wherein the shaft includes an arcuate flange, and the port wall includes a groove that receives the flange and locates the compound gate valve along the shaft axis.

9. The fluid valve of claim 1, wherein the compound gate valve includes a reinforcing gusset bridging the first and second gates.

10. The fluid valve of claim 1, wherein the compound gate valve includes first and second seals respectively supported on the first and second gates and configured to respectively engage the first and second ports to block its respective port.

11. The fluid valve of claim 1, wherein the first and second ports are arranged at an angle of less than 180° relative to one another.

12. The method of claim 1, wherein the housing includes first and second walls spaced apart from one another and adjoining port wall on opposite sides from one another, the first and second gates spaced from the first and second walls.

13. The method of claim 12, wherein the housing includes a cover secured to the first and second walls to enclose the compound gate valve within a fluid cavity in selective fluid communication with the first and second ports and a third port.

14. A thermal management system comprising:
at least one component including a battery;
a heat exchanger; and
wherein the fluid valve of claim 1 is fluidly arranged between the battery and the heat exchanger.

15. A method of operating a fluid valve, comprising:
providing a port wall providing first and second ports;
supporting first and second gates on a shaft having a shaft axis, the shaft operatively coupled to an output drive;
moving the output drive; and
rotating the first and second gates about the shaft axis between a first position in which the first gate seals against a first port and a second position in which the second gate seals against the second port, wherein a location of the shaft axis is configured to remain fixed relative to the port wall during rotation of the shaft between the first and second positions.
